(19) United States
(12) Patent Application Publication
(10) Pub. No.: US 2009/0070069 A1
(43) Pub. Date: Mar. 12, 2009

(54) APPARATUS AND METHOD FOR OPTIMIZING MEASUREMENT REPORTING IN A FIELD DEVICE

(75) Inventors: Kai T. Bouse, Tellico Plains, TN (US); Richard W. Piety, Knoxville, TN (US)

Correspondence Address: LUEDEKA, NEELY & GRAHAM, P.C., P O BOX 1871, KNOXVILLE, TN, 37901, US

(73) Assignee: CSI Technology, Inc., Wilmington, DE (US)

(21) Appl. No.: 12/205,352

(22) Filed: Sep. 5, 2008

Related U.S. Application Data
(60) Provisional application No. 60/970,738, filed on Sep. 7, 2007.
(60) Provisional application No. 60/971,185, filed on Sep. 10, 2007.

(51) Int. Cl. G06F 17/18; G06F 15/00

(52) U.S. Cl. 702/179; 702/182

(57) ABSTRACT

A machine data collection system compares a plurality of measured values to one another and determines the measured value indicating a worst-case condition. The machine data collection system then reports the worst-case measured value across the control network. In some embodiments, the measured values are normalized based on each individual measurement's typical range, or a user-defined operating range, thereby producing a plurality of normalized values each corresponding to one of the plurality of measured values. The data collection system compares the plurality of normalized values to a nominal value and determines the normalized value indicating the worst-case condition. The system reports the measured value corresponding to the worst-case normalized value. In some embodiments, the data collection system also reports the worst-case normalized value across the control network.

### REFERENCES TO RELATED APPLICATIONS

This application claims priority to U.S. provisional application Ser. No. 60/970,738 filed Sep. 7, 2007, titled “Optimizing Measurement Reporting in a Field Device by Roll-Up Processing,” the entire contents of which are incorporated herein by reference.

This application also claims priority to U.S. provisional application serial number filed Sep. 10, 2007, titled “Optimizing Measurement Reporting in a Field Device by Roll-Up Processing,” the entire contents of which are incorporated herein by reference.

### FIELD

This invention relates to the field of vibration monitoring systems for use in detecting machine fault conditions and analyzing machine performance. More particularly, this invention relates to an apparatus and method for optimizing measurement reporting in a field device.

### BACKGROUND

Field devices operating in a control network typically measure values indicating characteristics of machines to support performance analysis and machine maintenance tasks. Examples of machine operational characteristics include vibration, pressure, temperature, flow rate and the like. A field device typically reports its measured values to a host computer over the control network. The number of measured values reported varies depending on the type of field device.

Normally, each individual measured value reported by a specific field device must be exposed through an input/output (I/O) channel. Typically, there is a one-to-one mapping, that is, one channel reserved for one measured value. Thus, the number of I/O channels for a field device usually equals the number of values being measured. Each I/O channel communicates its measured value with the network backbone.

Most control networks have limited resources related to bandwidth and timing. As increasingly complex field devices have been introduced in the industry, the number of measured values available has increased substantially, and may easily exceed one hundred or more per device. A field device communicating a high number of measured values across a high number of channels requires a great deal of bandwidth. This may cause difficulties for the control network because of the various other field devices which must also communicate over the control network. This may detrimentally affect control timing or result in a loss of reporting timeliness, or both.

What is needed, therefore, is a data communication system for field devices configured to minimize the number of necessary I/O channels while maintaining communication of relevant and important data.

### SUMMARY

The above and other needs are met by an apparatus and method for comparing a plurality of measured values to a nominal value and determining the measured value indicating a worst-case condition. Then, the measured value indicating the worst-cast condition is communicated over a control network.

Specifically, a method is disclosed for reporting measurement values from at least one field device connected by at least one communication channel to a host computer over a control network. The method includes sensing a plurality of machine conditions, generating a plurality of measured values each corresponding to one of the machine conditions, and determining a worst-case value from the plurality of measured values. The worst-case value is one of the measured values that differs most from a nominal value. Finally, the method includes communicating the worst-case value to the host computer over the control network via the communication channel.

In some embodiments, the communication channel has units associated with it, and the method includes dynamically defining the units associated with the first communication channel and determining which of the plurality of measured values have the same units as those associated with the communication channel. The worst-case value is then determined only from those measured values determined to have the same units as those associated with the communication channel.

In alternate embodiments, a method for reporting measurement values from at least one field device connected by at least one communication channel to a host computer over a control network is provided. The method includes sensing at the field device a plurality of machine conditions, generating a plurality of measured values each corresponding to one of the machine conditions, normalizing each of the measured values based at least in part on a normalization scale, thereby producing a plurality of normalized values, each corresponding to one of the plurality of measured values, comparing the plurality of normalized values against one another to determine a worst-case normalized value, wherein the worst-case normalized value is one of the normalized values that differs most from a nominal value, and communicating measurement information over the control network to the host computer.

In various embodiments of this method, the measurement information includes the worst-case normalized value, the measured value corresponding to the worst-case normalized value or both. Furthermore, in various embodiments, the measured value corresponding to the worst-case normalized value is communicated via a first communication channel and communicating the worst-case normalized value via a second communication channel over the control network.

In accordance with other aspects of the invention, a field device reports machine measurement values via at least one communication channel to a host computer over a control network. The field device includes a memory device for storing first normalization scale information, a sensor configured for sensing a machine condition and for providing a sensor signal corresponding to the machine condition, and a processor connected to the memory device and the sensor. The processor receives the sensor signal and generates a measured value corresponding to the sensor signal. The processor also normalizes the measured value based at least in part on the first normalization scale information stored in the memory device, thereby producing a first normalized value corresponding to the measured value. The processor then determines a worst-case normalized value which is a normalized value that differs most from a nominal value. The field device also includes a communication interface connected to the processor and configured for communicating over the control network.

In various embodiments of the field device, the communication interface is configured for communicating at least the measured value corresponding to the worst-case normalized value via a first communication channel, communicating at least the worst-case normalized value via a first communication channel, or both. In another embodiment, the communication interface is configured for communicating the measured value corresponding to the worst-case normalized value via a first communication channel and communicating at least the worst-case normalized value via a second communication channel.

In various embodiments, the memory device is for storing second normalization scale information, the sensor is configured for sensing a second machine condition and for providing a second sensor signal corresponding to the second machine condition, and the processor is for receiving the second sensor signal and generating a second measured value corresponding to the second sensor signal. The processor is also for normalizing the second measured value based at least in part on the second normalization scale information stored in the memory device, thereby producing a second normalized value corresponding to the second measured value, and for determining the worst-case normalized value by comparing the first normalized value and the second normalized value with a nominal value.

In accordance with other aspects of the invention, a machine measurement reporting apparatus for reporting machine measurement values via at least one communication channel over a control network is disclosed. The apparatus includes a memory device for storing normalization scale information, a plurality of sensors each configured for sensing a machine condition and for providing a sensor signal corresponding to the sensed machine condition, and a processor connected to the memory device and the plurality of sensors. The processor receives the plurality of sensor signals and generates a plurality of measured values each corresponding to one of the plurality of sensor signals. The processor also normalizes each of the measured values based at least in part on the normalization scale information stored in the memory device, thereby producing a plurality of normalized values each corresponding to one of the plurality of measured values and determines a worst-case normalized value which is a normalized value that differs most from a nominal value. The apparatus also includes a communication interface connected to the processor and configured for communicating over the control network using a control protocol.

In various embodiments, the communication interface is configured for communicating at least the measured value corresponding to the worst-case normalized value via a first communication channel over the control network, communicating at least the worst-case normalized value via a first communication channel over the control network or both. In another embodiment, the communication interface is configured for communicating the measured value corresponding to the worst-case normalized value via a first communication channel over the control network and communicating the worst-case normalized value via a second communication channel over the control network.

In another embodiment, the control network includes at least one host computer, and the communication interface is configured to communicate over the control network with the at least one host computer.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a control network including a prior art field device communicating across several I/O channels;

FIG. 2 depicts a control network including a field device communicating across a single I/O channel;

FIG. 3 depicts a control network including a field device communicating across a single I/O channel with additional components of the field device depicted.

FIG. 4A is a flowchart of a method for optimizing measurement reporting in a control network; and

FIG. 4B is a flowchart of a second method for optimizing measurement reporting in a control network.

### DETAILED DESCRIPTION

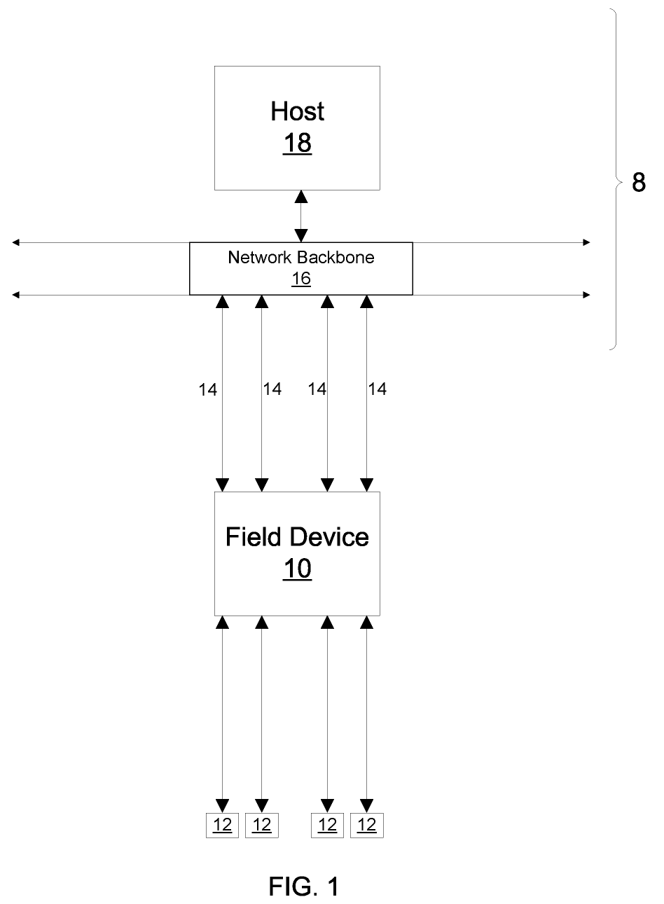

Referring to FIG. 1, a field device 10 is shown, such as may be used in the FOUNTDATION™ fieldbus environment or other control network 8. A plurality of sensors 12 sense conditions of a machine or machines and communicate sensor signals corresponding to those conditions to the field device 10. The field device 10 then communicates the measured values, or values corresponding to the measured values, across one or more I/O channels 14. Each individual measured value is communicated across a unique I/O channel 14 to a network backbone 16 of the control network 8. One or more host computers 18 are also connected to the network backbone 16 for receiving communications from the control network 8. In this case, the host 18 receives multiple measured values and subsequently determines which, if any, measured values indicate that a monitored machine requires attention. This configuration necessarily requires a number of I/O channels 14 equal to the number of measured values taken by the sensors 12 and communicated to the field device 10. Each of the I/O channels 14 requires bandwidth and takes up a slot on the control-protocol network 8.

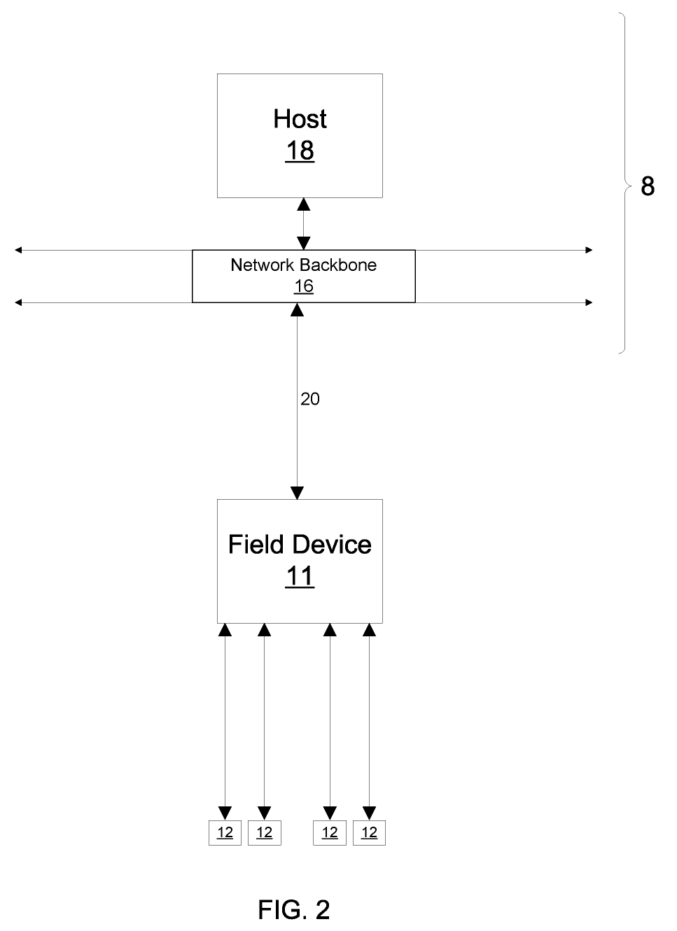

In a preferred embodiment depicted in FIG. 2, a field device 11 requires only one I/O channel 20 for communicating across the control network 8. Similar to the configuration shown in FIG. 1, a plurality of sensors 12 each sense conditions of a machine or machines and communicate sensor signals to the field device 11. However, using a process described below, the field device 11 minimizes the control network 8 resources needed to communicate relevant information related to the measured values.

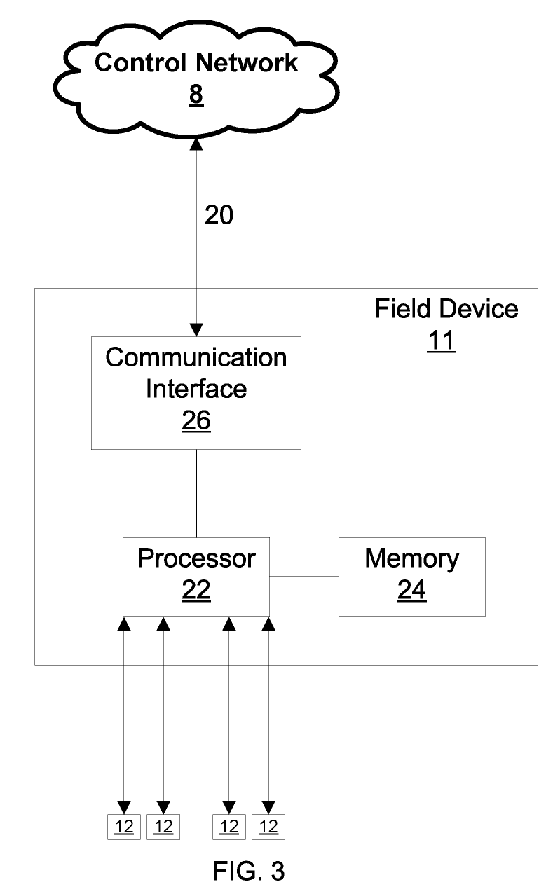

Referring to FIG. 3, the components of field device 11 are shown. The field device 11 has a processor 22 connected to a memory device 24. The processor 22 also is connected to the sensors 12 and a communication interface 26. The processor controls the communication interface 26, which is configured for communicating over the control network 8 via I/O channel 20.

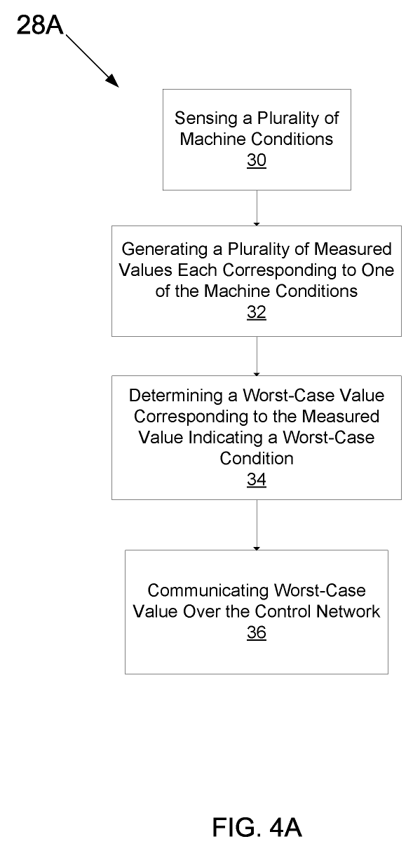

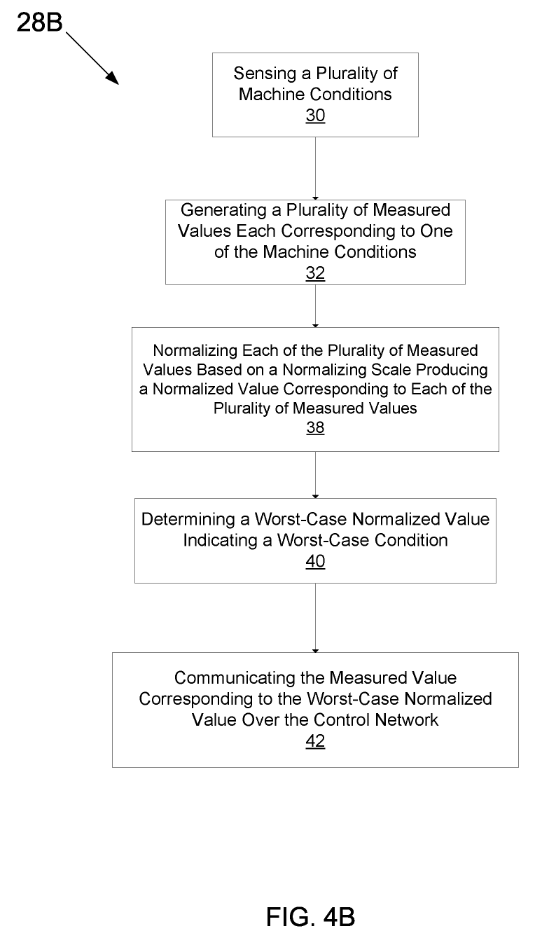

With reference now to FIG. 4A, a method 28A is depicted which uses the field device 11 of FIGS. 2 and 3 to minimize use of resources on the control network 8 and optimize measurement reporting. First, a plurality of machine conditions are sensed by the sensors 12 (step 30). The processor 22 of the field device 11 receives the sensor signals and generates a plurality of measured values each corresponding to one of the machine conditions (step 32). The processor 22 compares each of the measured values to a nominal value stored in the memory 24 and determines a worst-case value, which is the measured value indicating a worst-case condition (step 34). For example, consider a configuration with two measured values, A and B, where A is equal to 100 and B is equal to 200. If the nominal value for this measurement is zero, and a value farther from the nominal value indicates a worse condition than a value closer to the nominal value, the processor 22 chooses value B as the worst-case value.

Finally, the processor 22 instructs the communication interface 26 to communicate the selected worst-case value via I/O channel 20 over the control network 8 (step 36).

Referring back to step 30, in some applications a single sensor is used to sense a single machine condition such as vibration, temperature, pressure or the like. For example, the sensor may sense the vibration condition of the machine and continuously generate a sensor signal corresponding to the vibration of the machine. The processor 22 of the field device 11 receives the sensor signal and stores data corresponding to the sensor signal in the memory device 24 of the field device 11. The processor 22 then determines one or more measured values corresponding to the machine condition over a predefined period of time. For example, one vibration sensor may sense vibration of a machine for 90 seconds and generate a sensor signal corresponding to the vibration condition for the same period. The processor 22 receives the signal and breaks the signal into three equal periods of time. The processor 22 then determines a measured value for each of the three periods of time (step 32). Next, the processor 22 determines which measured value indicates the worst-case condition by comparing the measured values to a nominal value (step 34).

Referring now to FIG. 4B, a method 28B is depicted which is similar to the method 28A of FIG. 4A. A plurality of machine conditions are sensed (step 30) by the sensors 12 which generate a plurality of sensor signals, each corresponding to one of the machine conditions. The processor 22 receives the sensor signals and generates a plurality of measured values each corresponding to one of the machine conditions (step 32). The processor 22 then produces normalized values each corresponding to one of the measured values based on a normalizing scale (step 38). Next, the processor 22 compares each of the normalized values to a nominal value accessed from the memory 24 and determines a worst-case normalized value indicating a worst-case condition (step 40). Finally, the processor 22 instructs the communication interface 26 to communicate the measured value corresponding to the worst-case normalized value over the control network 8 (step 42). This process requires communication of only one value, and therefore requires only one I/O channel 20, thereby minimizing use of control network resources.

In other embodiments, the processor 22 instructs the communication interface 26 to communicate the worst-case normalized value (determined in step 40) over the control network 8. In yet other embodiments, the processor 22 instructs the communication interface 26 to communicate both the worst-case normalized value and the corresponding measured value. This communication can take place over the same I/O channel 20 in succession or dual I/O channels 14 can be used.

The method as described with reference to FIG. 4A above assumes that similar units of measurement are being compared, such as a vibration measurement value being compared to a vibration measurement value. This type of one-on-one comparison may not yield effective results if the two compared values are indicative of different machine conditions having different units. Further, in some cases, even measured values that are indicative of similar or the same machine conditions (such as vibration conditions measured at different locations on the same machine or using different types of sensors) cannot be directly compared because the measured values may indicate different machine conditions. For example, consider a situation in which an accelerometer sensor A communicates an acceleration reading of 7 Gs (9.8 m/s²=1 G) and a rate sensor B communicates a velocity reading of 1.0 in/s. In this case, sensor A is sensing a condition of a machine component having a possible range of 0.1 Gs to 40 Gs, and sensor B is sensing a condition of a machine component having a possible range of 0.001 in/s to 10 in/s. Thus, it is not readily apparent, absent some computation or further analysis, which reading is more severe (farthest from nominal), that is, which value is the “worst-case value.”

The method of FIG. 4B accounts for such differences in measurement units by normalizing the measured values using a normalization scale to produce normalized, unit-less values (step 38). Referring back to the example above, the possible range for the measured value from sensor A is 0.1 Gs to 40 Gs, where 40 Gs is the worst-case acceleration reading for the machine component monitored by sensor A. The normalized scale in this example is from 0.0 (least severe) to 1.0 (most severe). The measured value of 7 Gs, when normalized to this scale results in a normalized value of 0.17 (unit-less) on the normalized scale of 0.0 to 1.0. The range of measured values for sensor B is 0.001 in/s to 10 in/s, where 10 in/s is the worst-case velocity reading for the component monitored by sensor B. The normalized scale for sensor B is also 0.0 (least severe) to 1.0 (most severe) so that once the measured values are normalized, they can be compared directly to the normalized values from sensor A. The sensor B reading of 1.0 in/s normalizes to 0.10 (unit-less), which is less severe as compared to the normalized value for sensor A (0.17). In this example a linear interpolation is used for normalization. However, in other embodiments, different types of interpolation may be used, such as an exponential interpolation.

In a preferred embodiment, the measured value of sensor A (7 Gs) is communicated over the control network (step 38). In other embodiments, the normalized value of sensor A (0.17 unit-less) is also communicated, or the normalized value (0.17 unit-less) is communicated instead of the measured value (7 Gs).

The above example illustrates how a worst-case value may be determined by comparing two or more normalized values in the method of FIG. 4B. Notably, these methods do not necessarily provide hierarchical status. Some prior art multi-level systems perform a method wherein they choose a value from each lower level and combine them in various ways while moving up the hierarchy, ultimately to determine the “most important” status value at the conclusion of the method. Such status values are typically discrete states. In other words, it is impossible to differentiate between a status value that is barely above a particular state's lower threshold and another status value that almost reaches the next-highest state's threshold. On the other hand, the embodiments described herein involve actual measurement values as opposed to status values. The pool of measurement values from which the worst-case value is selected may be of any size, and the selection mechanism, that is, the comparison of measurement values and determination of the worst-case value, may be arbitrarily complex. These attributes provide advantages to a user who is collecting relevant trend data in their historical database. Such users are able to store actual measurement values, which are useful in data analysis, as opposed to status values which are less useful.

In alternative embodiments, the methods described above include dynamically defining the I/O channel units and restricting the selection pool to measured values which share those units. In a typical field device there is a one-to-one mapping between an I/O channel and the number of values being reported through that channel. For example, a pressure transmitter reports a value in units of pressure. Although the present invention allows the reporting of disparate measurement units using normalized severity, in some scenarios it may be advantageous to store actual values. It is desirable to define the measurement units associated with a channel so that storage of historical values in a database are consistent, even when selecting among measurements having different units as described above. It is also desirable to manage the units automatically for a user, when possible. A user, in such a situation, need not remember the exact configuration of a large number of installed devices. Although the units of vibration measurements are related to the type of the sensor used (such as an accelerometer measuring acceleration), the units may be converted using the techniques of integration and/or differentiation.

Further, when a user has the ability to customize the configuration of measurements, it is not possible for a measurement system manufacturer to know beforehand what units will be utilized. Defining a channel with known units for every possible conversion of every possible measurement is not practical. It is therefore desirable for a field device to be able to determine and automatically assign the units associated with an I/O channel dynamically. When a user has chosen not to use the normalization method of FIG. 4B, but rather is using the method of FIG. 4A, it is also desirable for the measurements that the user can select to report be restricted to those values that have compatible units.

By dynamically defining the I/O channel units and restricting the selection pool to measured values which share those units, the above goals can be achieved. This allows the user to maintain consistent historical trends in a process database without having to use the normalization method of FIG. 4B to “scrub” or remove the units from the measurements. This also simplifies the process by obviating the need for a user to remember the units of all measurements to determine which specific measurements are comparable.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention.

What is claimed is:

1. A method for reporting measurement values from at least one field device connected by at least one communication channel to a host computer over a control network, the method comprising:
(a) sensing a plurality of machine conditions;
(b) generating a plurality of measured values each corresponding to one of the machine conditions;
(c) determining a worst-case value from the plurality of measured values, wherein the worst-case value is one of the measured values that differs most from a nominal value; and
(d) communicating the worst-case value to the host computer over the control network via the communication channel.

2. The method of claim 1 wherein the communication channel has units associated with it, and the method further comprises:
dynamically defining the units associated with the first communication channel, and
determining which of the plurality of measured values have the same units as those associated with the communication channel,
wherein step (c) comprises determining the worst-case value only from those measured values determined to have the same units as those associated with the communication channel.

3. A method for reporting measurement values from at least one field device connected by at least one communication channel to a host computer over a control network, the method comprising:
(a) sensing at the field device a plurality of machine conditions;
(b) generating a plurality of measured values each corresponding to one of the machine conditions;
(c) normalizing each of the measured values based at least in part on a normalization scale, thereby producing a plurality of normalized values, each corresponding to one of the plurality of measured values;
(d) comparing the plurality of normalized values against one another to determine a worst-case normalized value, wherein the worst-case normalized value is one of the normalized values that differs most from a nominal value; and
(e) communicating measurement information over the control network to the host computer.

4. The method of claim 3 wherein the measurement information comprises the worst-case normalized value.

5. The method of claim 3 wherein the measurement information comprises the measured value corresponding to the worst-case normalized value.

6. The method of claim 5 wherein the measurement information further comprises the worst-case normalized value.

7. The method of claim 5 wherein step (e) further comprises communicating the measured value corresponding to the worst-case normalized value via a first communication channel and communicating the worst-case normalized value via a second communication channel over the control network.

8. A field device for reporting machine measurement values via at least one communication channel to a host computer over a control network, the field device comprising:
a memory device for storing first normalization scale information;
a sensor configured for sensing a machine condition and for providing a sensor signal corresponding to the machine condition;
a processor connected to the memory device and the sensor, the processor for receiving the sensor signal and generating a measured value corresponding to the sensor signal, for normalizing the measured value based at least in part on the first normalization scale information stored in the memory device, thereby producing a first normalized value corresponding to the measured value, and for determining a worst-case normalized value which is a normalized value that differs most from a nominal value; and
a communication interface connected to the processor and configured for communicating over the control network.

9. The field device of claim 8 wherein the communication interface is configured for communicating at least the measured value corresponding to the worst-case normalized value via a first communication channel.

10. The field device of claim 8 wherein the communication interface is configured for communicating at least the worst-case normalized value via a first communication channel.

11. The field device of claim 10 wherein the communication interface is configured for communicating the measured value corresponding to the worst-case normalized value via the first communication channel.

12. The field device of claim 10 wherein the communication interface is configured for communicating the measured value corresponding to the worst-case normalized value via a second communication channel.

13. The field device of claim 8 wherein the control network includes at least one host computer and wherein the communication interface is configured to communicate over the control network with the host computer.

14. The field device of claim 8 wherein:
the memory device is for storing second normalization scale information;
the sensor is configured for sensing a second machine condition and for providing a second sensor signal corresponding to the second machine condition;
the processor is for receiving the second sensor signal and generating a second measured value corresponding to the second sensor signal, for normalizing the second measured value based at least in part on the second normalization scale information stored in the memory device, thereby producing a second normalized value corresponding to the second measured value, and for determining the worst-case normalized value by comparing the first normalized value and the second normalized value with a nominal value.

15. A machine measurement reporting apparatus for reporting machine measurement values via at least one communication channel over a control network, the apparatus comprising:
a memory device for storing normalization scale information;
a plurality of sensors each configured for sensing a machine condition and for providing a sensor signal corresponding to the sensed machine condition;
a processor connected to the memory device and the plurality of sensors, the processor for receiving the plurality of sensor signals and generating a plurality of measured values each corresponding to one of the plurality of sensor signals, for normalizing each of the measured values based at least in part on the normalization scale information stored in the memory device, thereby producing a plurality of normalized values each corresponding to one of the plurality of measured values, and for determining a worst-case normalized value which is a normalized value that differs most from a nominal value; and
a communication interface connected to the processor and configured for communicating over the control network using a control protocol.

16. The machine measurement reporting apparatus of claim 15 wherein the communication interface is configured for communicating at least the measured value corresponding to the worst-case normalized value via a first communication channel over the control network.

17. The machine measurement reporting apparatus of claim 15 wherein the communication interface is configured for communicating at least the worst-case normalized value via a first communication channel over the control network.

18. The machine measurement reporting apparatus of claim 17 wherein the communication interface is configured for communicating the measured value corresponding to the worst-case normalized value via the first communication channel over the control network.

19. The machine measurement reporting apparatus of claim 17 wherein the communication interface is configured for communicating the measured value corresponding to the worst-case normalized value via a second communication channel over the control network.

20. The machine measurement reporting apparatus of claim 15 wherein the control network includes at least one host computer and wherein the communication interface is configured to communicate over the control network with the at least one host computer.
